(19) United States
(12) Patent Application Publication
(10) Pub. No.: US 2004/0264158 A1
(43) Pub. Date: Dec. 30, 2004

(54) Light source that can be used for scanning films

(75) Inventor: Patrice Lavergne, Monteynard (FR)

Correspondence Address: HESLIN ROTHENBERG FARLEY & MESITI PC, 5 COLUMBIA CIRCLE, ALBANY, NY, 12203, US

(73) Assignee: KIS, Echirolles (FR)

(21) Appl. No.: 10/888,148

(22) Filed: Jul. 9, 2004

Related U.S. Application Data
(63) Continuation of application No. PCT/FR03/00362, filed on Feb. 5, 2003.

(30) Foreign Application Priority Data
Feb. 5, 2002 (FR) 02.01441

(51) Int. Cl. G03B 15/02

(52) U.S. Cl. 362/3

(57) ABSTRACT

A lamp type device associated with a reflector illuminates a receiving surface of a light guide/former. An emitting surface of the light guide/former arranged proximate to a film, has substantially the dimensions of the film zone to be illuminated. The light guide/former is a single-piece part comprising two opposite planar surfaces, whereon one is receiving and the other emitting. The invention is useful for a device providing an intense and homogeneous light beam for film scanning analysis.

The present invention relates to a light source device. More particularly, but not exclusively, it relates to a device that delivers an intense uniform light beam for scanning films.

In general, it is known that, to digitize a film by scanning it, the film is made to run past an optoelectronic set up comprising, on one side, a light source capable of applying to the film a light beam of narrow rectangular cross section with a length approximately equal to the width of the film and, on the other side, an objective that projects the image of the illuminated part of the film onto an array of charge coupled detectors (CCDs).

For correct scanning, it turns out that the light intensity must be high and uniform over the entire illuminated area of the film.

To achieve this result, large slit lamps are used. However, the optical efficiency of this type of lamp is relatively low so that it is necessary to oversize it, with all the drawbacks that this entails (bulkiness, heat dissipation, uniformity of the light intensity, difficulty of integration, etc.).

The object of the invention is therefore more particularly to eliminate these drawbacks.

For this purpose, it proposes a light source comprising means for obtaining an intense uniform light beam comprising a lamp associated with a reflector illuminating the receiving face of a light shaper/guide, the emitting face of which, placed close to the film, has substantially the dimensions of the region of the film to be illuminated.

This light guide may, for example, consist of a bundle of optical fibers, the receiving ends of which are grouped together so as to define a receiving face whose dimensions correspond approximately to the cross section of the beam generated by the focused light source. The emitting ends are placed so as to obtain an emitting face whose shape and dimensions correspond to those of the region of the film to be illuminated.

The light shaper/guide may also, for example, be made from a flat one-part-piece, this piece comprising:

two main plane faces;

two faces—one the receiving face and the other the emitting face—which face each other so as to be perpendicular to the plane of symmetry of the two main plane faces; and

two lateral faces that join the receiving face to the emitting face.

Embodiments of the invention will be described below, by way of nonlimiting examples, with reference to the appended drawings in which:

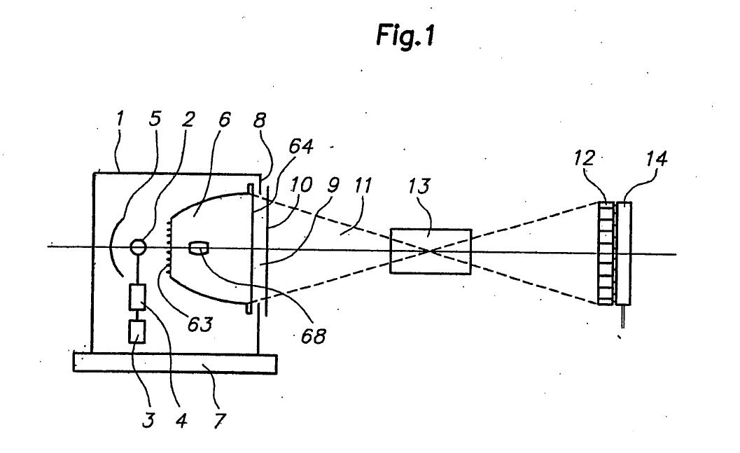

FIG. 1 is a schematic representation of a device according to the invention used for film scanning;

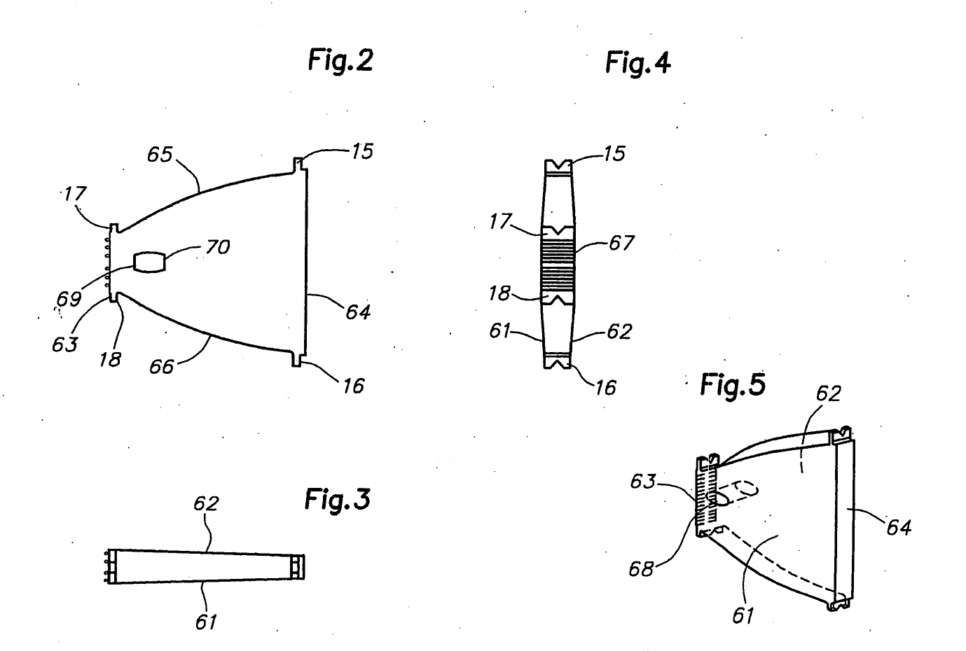

FIG. 2 is a side view of a light shaper/guide according to the invention;

FIG. 3 is a plan view of a light shaper/guide according to the invention;

FIG. 4 is a side view of a light shaper/guide according to the invention; and

FIG. 5 is a perspective view of a light shaper/guide according to the invention.

In the example shown in FIG. 1, the device according to the invention comprises a module 1, for example of parallelepipedal shape, comprising:

an isotropic light source 2 supplied by supply means 3 and control means 4;

a parabolic reflector 5 for reflecting, in a given direction, all of the radiation emitted by the isotropic light source 2;

a light shaper/guide 6 for generating a uniform light beam of rectangular shape on an emitting face 64;

a heat sink 7 for extracting the heat losses from the light source 2, from the reflector 5 and from the guide 6 of the light emitted by the light source 2; and

a slit 8 placed opposite the emitting face and of the same dimensions.

The module 1 generates a light beam 9 that illuminates the film 10 to be scanned. After the transmitted light beam 11 has passed through the film 10, it is focused onto the charge coupled device 12 (CCD arrays) by means of an optical device 13. The charge coupled device 12 is associated with a read register, consisting of a shift register 14, the whole assembly allowing the spatial information carried by the light beam 11 to be converted into temporal information; which is the result of the scanning of the image of that region of the film which is illuminated by the shaper/guide.

FIGS. 2, 3, 4 and 5 illustrate various views of the guide 6 according to the invention. The light shaper/guide 6 may, for example, be made from a flat one-part piece made of transparent material, such as molded polymethyl methacrylate (PMMA), this piece comprising:

two main plane faces 61, 62 that are slightly oblique with respect to each other and separated from each other by a distance that decreases on going from the receiving face to the emitting face;

two faces—one the receiving face 63 and the other the emitting face 64—which lie parallel to each other and perpendicular to the plane of symmetry of the two oblique faces 61, 62; and

two curved lateral faces 65, 66 in the form an ellipse, which respectively join the two transverse edges of the receiving face 63 to the two transverse edges of the emitting face 64.

The receiving face 63 has a rectangular shape falling within the light beam emitted by the lamp/reflector assembly.

This receiving face 63 includes a succession 67 of parallel scored lines with axes perpendicular to the plane of symmetry of the two faces 61, 62.

The light shaper/guide 6 furthermore includes, close to the receiving face 63, a through-orifice 68 that lies perpendicular to the plane of symmetry of the two oblique faces 61, 62.

The orifice 68 possesses an elliptical cross section truncated on the receiving face 63 side and on the emitting face 64 side of the light shaper/guide 6, a truncated portion 69 on the receiving face side being smaller than that 70 on the emitting face side.

The light guide includes, for fixing it, four fixing tabs 15 to 18 lying in the extension of the receiving face 63 and of the emitting face 64. These fixing tabs are provided with V-shaped centering notches.

The combination of the plane faces 61, 62, the receiving face 63, the emitting face 64, the two side faces 65, 66, the diffraction grating 67 and the through-orifice 68 makes it possible to obtain a uniform beam of rectangular shape capable of scanning a film.

The purpose of the scored lines 67 on the receiving face 63 is to diffuse the light received from the light source, inside the guide, and, in combination with the reflecting walls 61, 62, 63, 64, 65 and 66 of the guide and the through-orifice 68, associated with its two faces 69 and 70, to ensure uniformity of the light intensity at the emitting face 64. The light emanating from the central part of the receiving face 63 is reflected toward the elliptical lateral faces 65, 66 by the orifice 68, which acts as a convex mirror thus preventing light concentration in the central part of the emitting face 64 of the light shaper/guide 6.

It should be noted that the invention is not limited to the example described above. The function fulfilled by the through-orifice 68 may, for example, be fulfilled by a transparent body, possibly of different shape and of different diffraction index from that of air and of the guide 6.

1. A light source device that can be used for scanning films, comprising a lamp associated with a reflector that illuminates a receiving face of a light shaper/guide, an emitting face of the light shaper/guide, placed close to the film, having approximately the dimensions of a region of the film to be illuminated.

2. The device as claimed in claim 1, wherein said light shaper/guide is a one-part piece having two opposed plane faces, two faces, one of which is the receiving face and the other of which is the emitting face, and two lateral faces that join the receiving face to the emitting face.

3. The device as claimed in claim 2, wherein said plane faces are slightly oblique with respect to each other and separated from each other by a distance that decreases on going from the receiving face to the emitting face.

4. The device as claimed in claim 2, wherein said receiving face and said emitting face lie parallel to each other and perpendicular to a plane of symmetry of the two oblique faces.

5. The device as claimed in claim 3, wherein the receiving face includes a succession of parallel scored lines with axes perpendicular to a plane of symmetry of the two oblique faces.

6. The device as claimed in claim 2, wherein said lateral faces are curved in the form of an ellipse and join two transverse edges of the receiving face to the transverse edges of the emitting face, respectively.

7. The device as claimed in claim 1, wherein the reflector is parabolic.

8. The device as claimed in claim 3, wherein said light shaper/guide includes an element integrated into the guide, possessing a diffraction index different from that of said guide.

9. The device as claimed in claim 8, wherein said element integrated into the guide comprises a through-orifice lying perpendicular to a plane of symmetry of said oblique faces.

10. The device as claimed in claim 9, wherein said orifice is of truncated oval shape.

11. The device as claimed in claim 1, wherein the light shaper/guide includes four fixing tabs.
